(19) United States
(12) Patent Application Publication
(10) Pub. No.: US 2004/0260704 A1
(43) Pub. Date: Dec. 23, 2004

(54) User-requested remote assistance for printing devices

(76) Inventor: Keith E. Moore, Santa Clara, CA (US)

Correspondence Address: HEWLETT-PACKARD COMPANY, Intellectual Properry Administration, P.O. Box 272400, Fort Collins, CO, 80527-2400, US

(21) Appl. No.: 10/601,906

(22) Filed: Jun. 23, 2003

(51) Int. Cl. G06F 17/00

(52) U.S. Cl. 707/100

(57) ABSTRACT

A printing device (printer, fax machine, copier, etc.) is configured to access support from a remote location in response to a user affirmatively engaging a button on the printing device. The printing device generates and transmits a request for assistance to a remote support location in response to the user's request. The printing device also provided an indication to the user that the request for assistance has been transmitted. In some embodiments, the printing device can receive a response from the remote location or otherwise engage in interactive communication therewith. The aforementioned functionalities can be implemented within a printing device, or as an add-on card to be used with a printing device.

### BACKGROUND

Many printers, facsimile machines, and copiers require relatively high and/or frequent amounts of maintenance. High maintenance arises, for example, from the presence of moving parts (rollers, platens, etc.), ink-handling mechanisms (whether ink- or toner-based), and accumulation/intrusion of physical debris (dust, paper, toner powder, dropped paper clips, removed staples, etc.). Similarly, normal or preventive maintenance may arise from the need to replace paper, toner, charging elements or fuser oil, to clear paper jams, to vacuum out dust, and/or to maintain the alignment of print heads or other parts.

For convenience, these and other paper-handling devices shall be referred to simply as “printers.” Some printer maintenance tasks can be performed easily by the user, while other tasks require professional assistance (assistance from the computer systems or facilities manager, service call by a factory technician, etc.). Unfortunately, it can be difficult for users to even know when they should try to fix a problem themselves, versus calling for help, because they do not know how to identify the problem. For example, a paper feeding failure could be caused by either a relatively simple paper jam, or a complicated mechanical part failure. Technicians can often guide users through removal of paper jams over the phone, while parts replacement might necessitate a service call or repair center visit. But if the user cannot determine the root cause of the paper feeding problem, the user will not know how to proceed.

Some printers currently available on the market contain sophisticated sensors and other internal monitoring devices, together with associated computer microprocessors and memory, to self-diagnose and/or record problems. However, such information is often stored in the device's memory in a manner that is either inaccessible, or accessible but incomprehensible, to the user. For example, some diagnostic information can only be read out by connecting sophisticated handheld electronic devices to the printer. Still other diagnostic information may be displayed on a control panel as error codes that are virtually meaningless to the layman.

Many modem printers are networked or otherwise connected to a communications system (perhaps even via a phone line connection). Such communications-enabled printers may include unidirectional and/or bidirectional communications and software deployed at a device administrator's computer and/or at the device itself, to implement some or all of the following:

(a) monitoring of printer status (online/offline, toner/ink remaining, paper tray status, cover open, warming up v. ready, etc.);

(b) central distribution of code (drivers, fonts, macros, etc.) across the enterprise;

(c) error messages (paper jams, out of toner, out of paper, etc.);

(e) total page count;

(f) monitoring of printing patterns (peak demand times, PCL v. PS jobs, etc.);

(g) monitoring of routine or preventive maintenance (by page count, toner usage, date/time, etc.);

(h) workload balancing;

(i) remote testing and diagnosis;

(j) automated reporting via email or other messaging techniques; and

(k) device identification (name, model, serial number, physical location, configuration, network address, status, etc.).

However, such information is not always helpful to users. For example, an intelligent networked printer may have the capability to inform a remote administrator of a problem that has occurred. Even so, a user waiting at the printer for an urgent job typically does not know if the administrator's computer has been informed, when it was informed, if the administrator has read the error message, or whether the administrator can fix the problem (e.g., a simple paper jam) or must call an outside technician. These difficulties may be especially acute in situations when there are no highly trained technical staff to handle the problems that are reported. For example, in many home or small office environments, the user is the administrator —and may not have any idea how to even use the device monitoring software.

Alternatively, useful information might be available in or from the printer, but inaccessible due to the system configuration. For example, remote access to the printer information might be denied for bandwidth/traffic control reasons, because of firewall restrictions, or otherwise.

Even when useful information is available and not restricted, it may still not be readily or timely accessible. For example, if there are large numbers of printers on the network, monitoring and diagnosis from the administrator's computer (e.g., periodically sending status queries to part or all of the printer population) may be inefficient if a high traffic volume is needed to interrogate the many printers.

In view of all the foregoing, a market exists for a printer that is able to generate a user-initiated request for assistance, which request can be transmitted to, and processed by, a remote support location.

### SUMMARY

An exemplary process for enabling a printing device to access support from a remote location includes: (a) receiving an affirmative request for an assistance from a user of a printer, the request having been triggered by the user's engaging a button on the printer; (b) generating and transmitting a request for assistance to a remote support location in response to the user's request; and (c) providing an indication to the user that a request for assistance has been transmitted.

An exemplary printer capable of communicating with a remote support location, comprises: (a) a printer engine; (b) an external button configured to be engaged by a user of the printer making an affirmative request for an assistance; (c) request management circuitry for generating and transmitting an assistance request in response to the user's affirmative request; and (d) a network interface for transmitting the assistance request to a remote location capable of communicating with the printer.

Other exemplary alternative embodiments and aspects are also disclosed. For example and without limitation, these may include speech-based user interfaces, local and remote diagnostics, and/or still other features disclosed in the detailed description following.

### BRIEF DESCRIPTION OF THE FIGURES

FIG. 1 illustrates a block diagram of an exemplary printer having remote support capability in response to a user-initiated request for assistance made at the printer.

FIG. 2 illustrates an exemplary process for requesting assistance in a one-way communication with a remote support location.

FIG. 3 illustrates an exemplary process extending the exemplary one-way process of FIG. 2 to two-way communication with the remote support location.

FIG. 4 illustrates an exemplary process for using the exemplary printer of FIG. 1 as a gateway to other devices.

### DETAILED DESCRIPTION

I. Overview

Section II describes an exemplary printer having remote support capability in response to a user-initiated request for assistance made at the printer. Section III describes an exemplary process for requesting assistance in a one-way communication with a remote support location, and Section IV illustrates an exemplary process for two-way communication with the remote support location. Finally, Section V illustrates an exemplary process for using the printer as a gateway to other devices.

II. An Exemplary Printer

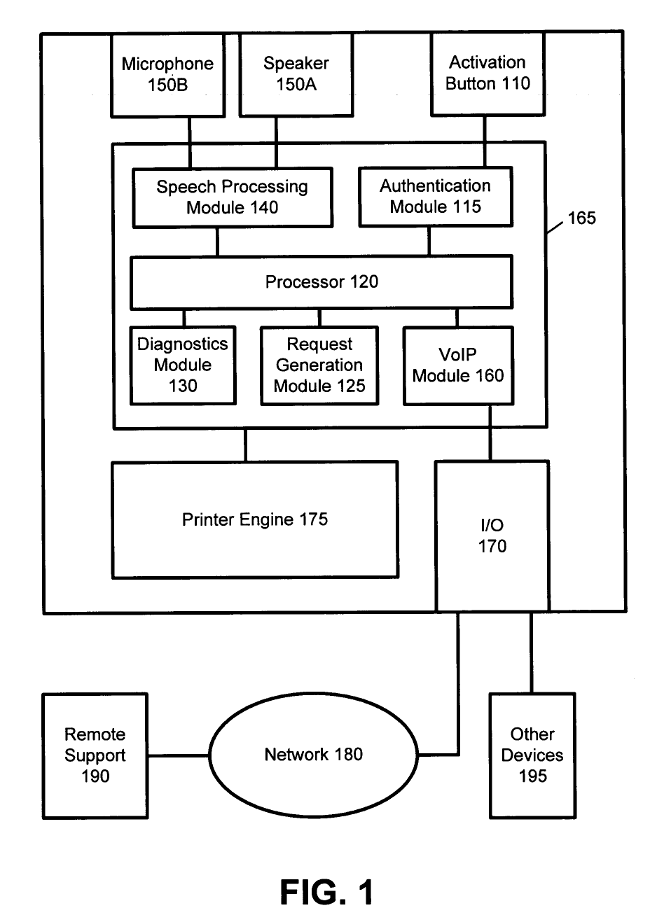

FIG. 1 illustrates an exemplary printer capable of detecting a user-initiated request for assistance made at the printer, and transmitting an appropriate request for assistance to a remote support location.

The exemplary printer includes an activation button 110, which the user can push to generate an affirmative request for assistance (as opposed to, say, the wholly passive or automatically-generated requests for assistance already known in the art). Activation button 110 may comprise an actual button, as well as other functionally similar devices. Such other devices may include mechanical devices such as switches or knobs, pressure-sensitive pads, optical sensors, keypads, or still other forms of user interfaces.

In some implementations, it may be desirable to ensure that only an authorized user is able to request assistance. This may be done for security, financial (e.g., when support is subscription-based), or other reasons. Thus, an optional authentication module 115 may be used to authenticate or otherwise verify the identity of the user. More details about user authentication will be set forth in Section III below.

The printer also includes a request generation module 125 configured to generate the request, with content and formatting appropriate to the communications protocol with the remote location. A diagnostics module 130 may optionally provide diagnostic information, to be appended in the request, about a print job, printer status, printer identity, or even about other devices 195.

The request for assistance is transmitted through I/O interface 170, over network 180, to remote support location 190. In an exemplary embodiment, the remote support location is independent of the owner of the printer.

The I/O interface 170 may be a specially configured interface, or it may be a preexisting interface available in the printer. For example, many printers have parallel, serial, USB, Ethernet or other forms of ports for accepting network cards, font cartridges, and the like. Such interfaces could readily be used as the I/O interface 170.

The exemplary printer also includes an optional speaker 150A, which could be used for a variety of purposes under control of request generation module 125 and other(s) of the modules depicted in FIG. 1. For example, speaker 150A could be used to confirm to the user that his request for assistance has been received and processed. Of course, many other mechanisms could also be used to signal generation and/or transmission of the request for assistance. For example, a visual mechanism might include a colored or flashing light in the form of an LED embedded in the printer case (not shown) or incorporated within the activation button 110, or a LCD or other form of display panel if alphanumeric messages are desired. The same mechanism, or a variant thereof, could also be used to signal to indicate the status of the printer even after the initial request for assistance. For example, if a blinking light were used to indicate transmission of the request for help, the light could thereafter remain continuously lit, while awaiting service, to indicate that the printer is unavailable. Thus, the signaling mechanism (whether light, sound, or alphanumeric display, or otherwise) can provide useful information not only to the user who called for assistance, but also to other actual or potential users of the printer.

The exemplary printer also includes an optional microphone 150B, which could be used in cooperation with activation button 110 to provide the authentication information. Microphone 150B could even be used as an exemplary voice-initiated form of activation button 110, whereby the user “pushes the button” by speaking into the microphone. As needed, an exemplary speech processing module 140 cooperates with microphone 150B to digitize and otherwise process the user's speech into any required form. More generally, speech processing module 140 is used to recognize, and extract useful information from voice inputs at microphone 150B. For example, the speech processing module might be configured to listen for and recognize certain predetermined verbal inputs (e.g., “help,” user name, etc.) and issue the corresponding electronic signals for inclusion within the request for assistance. At the remote location, the electronic signals would be received and interpreted by corresponding electronic (e.g., software- and/or hardware-based) support mechanisms.

In some implementations, it may be useful for the user's speech to be transmitted verbatim to the remote location. For example the user might be experiencing an unusual problem not corresponding to a predetermined signal. Or, the remote location may provide human operators, rather than electronic support. In one exemplary embodiment, the user's speech is transmitted to the remote location using a “voice over IP” (or “VoIP”) protocol implemented in VoIP module 160, which could be connected to a telephone network 180 via a phone jack interface 170, with the VoIP network connection being provided via DSL operating over the POTS. Alternatively, VoIP module 160 (or some other type of voice transmission module) may be connected to network 180 via a wireless modem, Ethernet, cable, high speed modem, and/or other techniques now known or hereafter developed.

In an exemplary implementation, module 160 includes an audio codec, which converts (or encodes) an audio signal into a compressed digital form for transmission, then converts (or decodes) the compressed signal back into an uncompressed audio signal for replay. In the case of VoIP, the codec may use packet switching techniques for transmitting data, whereby the data are divided into small packets that are transmitted over the network. Each small packet typically includes an address telling the network the packet's destination. At the destination (e.g., at remote location 190), a VoIP receiver (not shown) aggregates the packets and reassembles them into the original data (e.g., speech). The transmission and reception in VoIP are performed using a common protocol, such as H.323 or SIP.

As yet another alternative, the user's voice message could be recorded to an audio file (e.g., using a .WAV file or other format known to those skilled in the art or hereafter developed), and the file could be transmitted to the remote location as part of the diagnostic information. Indeed, the file is not limited to audio information, but could also include any form of audiovisual information (i.e., audio and/or visual images). For example, images could be captured using a digital camera and uploaded to the printer through an I/O port (not shown) or perhaps from a computer connected to the printer. Image transmission would be useful, for example, where the user cannot adequately describe the problem using words alone.

In the foregoing, all communications were described in an outbound (i.e., one-way) context from the printer to the remote location 190. However, another exemplary implementation could extend the printer-remote location communications to further include (i.e., two-way) return communications from the remote location 190 to the printer. If a service call is required, a scheduled date/time for the service call could be provided to the user in confirmation of receipt and processing of the request by the remote support location.

In an exemplary printer configured for two-way communication, responses from the remote location 190 would arrive via network 180 at I/O interface 170. If the communications included speech (e.g., from an operator at remote location 190), they could be processed using VoIP module 160, reconverted to speech using speech processing module 140, and outputted through speaker 150A. Non-speech communications could be handled by other appropriate modules (not shown) in the printer.

Those particular modules used in any given implementation serve as the request management circuitry for that implementation. In the exemplary implementation of FIG. 1, these are denoted by box 165.

In all of the foregoing, some or all of the request management circuitry could be implemented as software-based logic instructions stored in one or more computer-readable memories and executed using processor 120. The processor 120 is also configured to facilitate control among the various modules in the printer, as appropriate.

Alternatively, some or all of the request management circuitry could be implemented in hardware, perhaps even eliminating the need for a separate processor 120, if the hardware modules contain the requisite processor functionality. The hardware modules could comprise PLAs, PALs, ASICs, and still other devices for implementing logic instructions known to those skilled in the art or hereafter developed.

In general, then, the modules comprising the request management circuitry should be understood to include any circuitry, program, code, routine, object, component, data structure, etc., that implements the specified functionality, whether in hardware, software, or a combination thereof. The software and/or hardware would typically reside on or constitute some type of computer-readable media which can store data and logic instructions that are accessible by the computer or the processing logic. Such media might include, without limitation, hard disks, floppy disks, magnetic cassettes, flash memory cards, digital video disks, removable cartridges, random access memories (RAMs), read only memories (ROMs), and/or still other electronic, magnetic and/or optical media known to those skilled in the art or hereafter developed.

It should be further understood that the aforementioned description of modules comprising the request management circuitry is merely exemplary. Thus, various of the modules could be combined into a single module, or still other modules besides those described above could also be used to provide the illustrated functionality.

For example, yet another way to eliminate processor 120 (in whole or in part) would be to execute some or all of the request management functions using a preexisting processor within printer engine 175. For example, many modem printers have relatively powerful processors for networking (e.g., LAN) capabilities, or for handling dozens or even hundreds of fonts. Such processors can handle some or all of the processing burden that would otherwise be borne by processor 120.

Yet another way to leverage existing printer capabilities is to deploy some or all of the request management circuitry as an add-on card or cartridge connectable to the printer's preexisting I/O interface. In an exemplary implementation, the add-on card would also include its own I/O interface to replicate the I/O interface occupied by the add-on card, so that the printer's ability to connect to a LAN, use font cards, etc. is not lost by use of the add-on card.

III. An Exemplary Process for One-Way Communication with a Remote Support Location

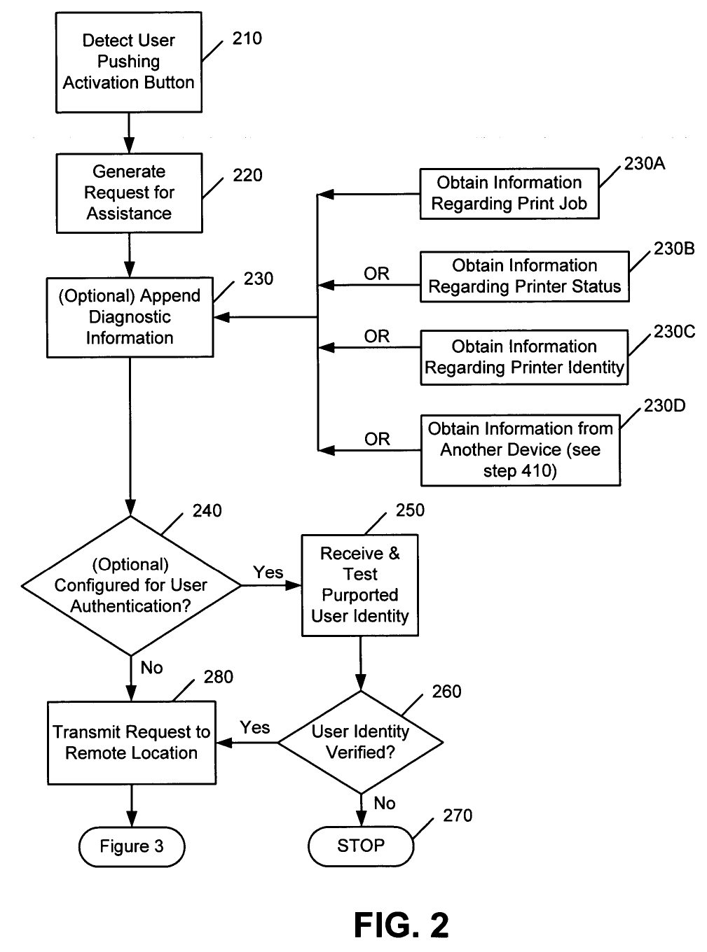

FIG. 2 illustrates an exemplary process for requesting assistance in a one-way communication with a remote support location. At step 210, the printer detects the user affirmatively requesting assistance (e.g., by pushing activation button 110) at the printer. At step 220, a request for assistance is generated (e.g., by request generation module 125). At step 230, any appropriate form of diagnostic information may be appended to the request. For example, at step 230A, the diagnostic information might include information about a pending print job.

As another example, at step 230B, the diagnostic information might include information about the printer status. The printer status could indicate a problem with the printer, such as a need for supplies (e.g., toner, paper, etc.), a need for repair (e.g., a part that is broken or otherwise in need of replacement), or a need for service (e.g., a paper jam, etc.). The printer status could also include device configuration information, numbers of pages printed, number of hours operational, and other asset management information. The printer status could also include audit/event log information —where the condition being diagnosed (in response to the user's affirmative request for assistance) includes auditing the use, or detecting excessive or unauthorized use, of the printer. One advantage of providing such logs directly from the printer to the remote location (as opposed to, say, through a PC connected to the printer) is that such logs might be more secure against tampering.

As still another example, at step 230C, the diagnostic information might include information pertaining to the printer's identity, such as its make, mode, serial number, location, owner, etc. Such information could be useful for diagnosing a printer problem, or for remote tallying of inventory (which is itself a form of diagnosis).

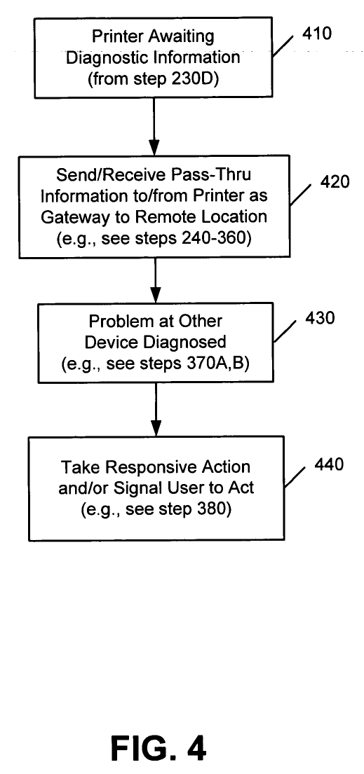

As yet another example, at step 230D (to be described in more detail in FIG. 4), the diagnostic information might include information pertaining to other devices 195 that are connected to the printer.

At step 240, if the printer is configured for user authentication, then at step 250, the printer (e.g., via authentication module 115) receives and tests the purported user identity. The user's identity may be supplied in the form of a keyed-in PIN (if the printer has a keypad), as a biometric identifier such as a speech pattern or a fingerprint, etc. (in which case the printer might include a biometric reader, either per se or as part of activation button 110), by a digital certificate or other identifier provided by an authentication token (in which case the printer might include a token reader, either per se or as part of activation button 110). The token could take any desired form (e.g., badge, dongle, card, fob, etc.), and the token reader would include the appropriate form of interface (whether by mechanical, magnetic, optical, infrared, radio frequency, or otherwise). In general, any now known or future developed authentication scheme can be used, depending on the particular implementation.

Indeed, authentication could even be performed at the remote location, instead of at the printer. In that case, the user's identity would be included in the diagnostic information, to allow the remote location to diagnose (i.e., authenticate) the user's identity, and the request for assistance transmitted to the remote location would request delivery of the authentication results from the remote computer to the printer.

At step 260, if the user's identity is verified, then at step 280 the request is transmitted to the remote location. At step 260, if the user's identity is not verified, then at step 270 the process ends (or perhaps resets to step 250).

Of course, user authentication can be implemented in a manner other than that shown in FIG. 2. For example, authentication could be executed before appending diagnostic information at step 230, or even before requesting assistance at step 220. Or, if authentication is not used, then at step 280, the request is simply transmitted to the remote location after appending the diagnostic information (if at all).

Still other variations in the exemplary process illustrated in FIG. 2 are possible. For example, at any point after detecting the user's help request at step 210, the printer could attempt to resolve the request locally before generating and transmitting a request for assistance to the remote location. Thus, relatively simple issues might be resolved by automated programs on-board the printer, while more difficult issues might be forwarded to the remote location, perhaps together with diagnostic information regarding local attempts (if any) to resolve the issue. For example, a minor issue such a paper jam might be resolvable by issuing verbal paper-clearing instructions to the user through speaker 150A, while paper jams that remain uncleared despite user efforts might trigger a request for remote assistance.

In some embodiments, a firewall might be deployed to restrict communications to the remote location. In that case, the printer could be equipped with software and/or hardware to open a channel through the firewall to transmit to the remote location. Firewall and channeling technology is well known and widely commercially available; any currently known or hereafter developed technology may be used as desired in accordance with a particular implementation.

Another exemplary application of the process described in FIG. 2 includes secure printing. For example, when printing highly sensitive materials over a shared printer, a user might wish printing to be suspended until the user is physically at the printer. In this example, the remote location might include a computer sending a print job to the printer, and the condition being diagnosed might include whether the user is standing by the printer. The user's presence could be signaled by the user's pressing of the activation button at step 210 (perhaps even with optional user authentication), the diagnostic information at step 230 would diagnose (i.e., confirm) the fact that the user is present, and the request for assistance transmitted to the remote location would request delivery of the print job from the remote computer to the printer. Yet another form of suspending delivery might include re-routing the print job to a secure location, for later pickup by or distribution to the user.

Various of the exemplary embodiments and aspects illustrated above allow the return of information (authentication results, paper jam clearing assistance, print job delivery, etc.) from the remote location to the printer. If the printer is equipped with a firewall to restrict external communications, the remote location could be equipped with software and/or hardware to open a channel through the firewall to transmit to the printer. Absent a mechanism for the direct return of such information to the printer, the information could be indirectly returned to the user, for example through an out-of-band link such as email, telephone, etc.

IV. An Exemplary Process for Two-Way Communication with a Remote Support Location

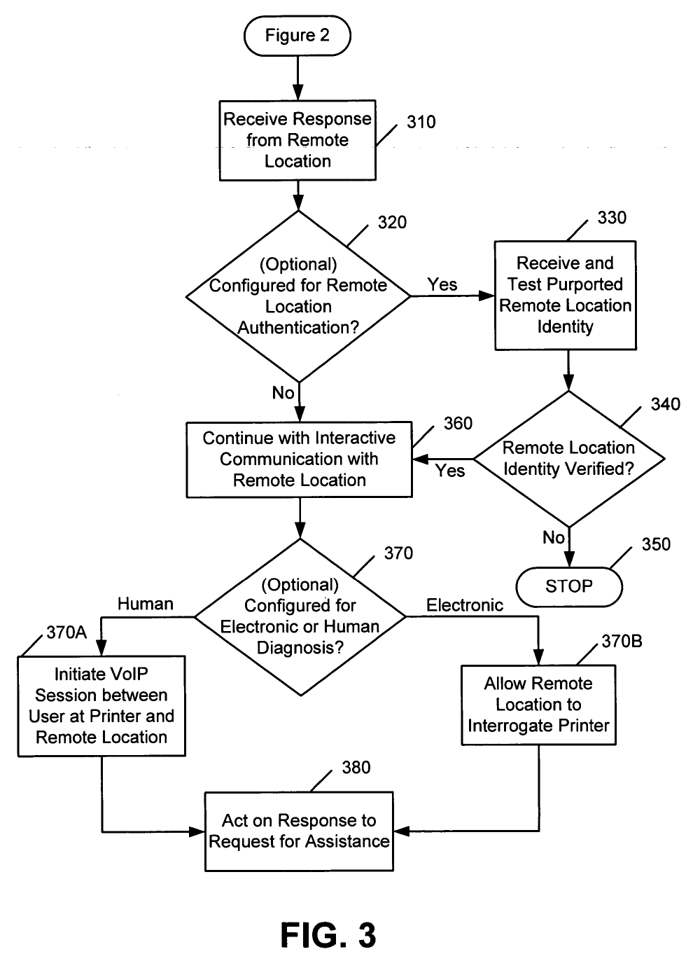

FIG. 2 illustrated an exemplary process for requesting assistance in a one-way communication with a remote support location. FIG. 3 illustrates additional functionality which, together with the one-way functionality in FIG. 2, provides two-way communication between the remote location and the printer.

At step 310, a response from the remote location is received at the printer. At step 320, if the printer is configured for remote location authentication, then at step 330, the printer (e.g., via authentication module 115) receives and tests the purported remote location identity. The remote location's identity may be supplied in accordance with any existing or future-developed authentication scheme, depending on the particular implementation.

At step 340, if the remote location's identity is verified, then at step 360 the printer continues its interactive communication with the remote location. At step 340, if the remote location's identity is not verified, then at step 350, the process ends (or perhaps resets to step 330). Of course, remote location authentication can be implemented in sequences other than that shown in FIG. 3.

As an alternative (not shown in FIG. 3) to true authentication, the printer could condition the interactive communication on receiving user authorization of the remote location. For example, after confirming identification information of the remote location supplied through speaker 150A, the user could signal authorization to proceed by clicking activation button 110.

Referring now to step 360, the interactive communication could be of virtually any type, depending on the particular implementation. For example, it might include arranging service call for the printer by personnel dispatched by the remote support location. Setting up the service call appointment (or other interactive communication) might require additional information not provided during step 230 of FIG. 1. Such information can be of virtually any type (e.g., in support of repairing broken parts, remedying malfunctions, reordering supplies, etc.), and can be supplied either manually, or electronically, as follows.

At step 370, if the printer is configured for human diagnosis, then at step 370A, a VoIP (or other) session is initiated between the printer and remote location to allow the user and remote location to exchange information to help set up the service call or otherwise diagnose the problem. Alternatively, at step 370, if the printer is configured for electronic diagnosis, then at step 370B, the remote location is permitted to interrogate the printer directly. Of course, some combination of human and electronic diagnosis could also be used.

Finally, at step 380, the printer (perhaps under control of the remote location or perhaps in response to user inputs at the printer) takes an appropriate action based on the response to the request for assistance. Such actions could include any action appropriate to the issue being diagnosed, whether for maintenance (e.g., adding paper, etc.), repair (e.g., broken part replacement), upgrading (e.g., downloading a new font or page description language), etc.

The aforementioned exemplary actions are all in the nature of restoring the printer to proper operating condition. Alternatively, the action could also include an operation in the normal course of use. For example, in the current state of the art, in order to reprocess some or all of a recently processed job, a person must initiate/control those actions at the transmitting entity (e.g., computer sending a print job, fax machine transmitting a fax, etc.). But by allowing the user at the printer to send requests to a remote device, and receive information back from the remote device, such actions can now be controlled at the printer.

For example: (a) the requested action could be printing additional copies of a recently printed job, and the response could include the content of the job; (b) the requested action could be printing duplicate copies of a job at another network printer (e.g., for a colleague in a different building), and the response could include confirmation of the remote printing; (c) the requested action could be reprinting a recently printed job in a different format (e.g., double-sided, stapled, etc.), and the response could include the content of the job with appropriate formatting; or (d) the requested action could be sending to a designated recipient an electronic (e.g., PDF) copy of a recently printed job, and the response could include confirmation of the transmission. These and still other actions currently available only using printer control software at a computer (or otherwise remotely from the printer) can now be readily executed at the printer using the two-way, interactive communication techniques disclosed herein and in FIG. 2.

Indeed, some of these actions can even be implemented using the one-way communication techniques of FIG. 1, if the user at the printer does not need to receive any information back from the remote location in real time. For example, when sending a duplicate copy job to a colleague in a different building, notification could come offline (e.g., via a telephone call with the colleague) or perhaps need not be provided at all.

V. An Exemplary Gateway to Other Devices FIG. 4 illustrates an exemplary process for using the printer as a gateway to another device 195 connected thereto. At step 410, the process continues from step 230D of FIG. 2, in which the printer is awaiting diagnostic information to be sent to the remote location.

At step 420, the information is obtained in pass-thru format from another device 195 via the printer acting as a gateway (and docking station). Depending on configuration, the information may be automatically downloaded (e.g., upon connection to the other device), or the other device may be interrogated upon user request (e.g., via an activation button on either the printer or the other device). Step 420 may include one-way communication (from the other device via the printer to the remote location), or two-way communications (back and forth between the other device and the remote location via the printer). More specifically, step 420 may include some or all of steps 240-280 of FIG. 2, and steps 310-360 of FIG. 3. As one example of an application of this step, if the other device is a computer using the printer, the printer might pass information about the computer's print spooler to the remote location. Virtually any other electronic device can be connected to the printer acting as a gateway. For example, in an entertainment application, these might include consumer electronic devices such digital cameras, camcorders, DVD recorders/players, etc.

At step 430, the problem at the other device 195 is diagnosed, using techniques appropriate to the specific implementation (e.g., steps 370A and/or 370B of FIG. 3). Finally at step 440 (similar to step 380 of FIG. 3), the remote location, the printer, and/or the other device can take a responsive action and/or signal the user to take such an action. For example, when the other device includes a computer driving the printer, one exemplary action might include updating a driver for the computer via the printer gateway.

VI. Conclusion

The foregoing examples illustrate certain exemplary embodiments from which other embodiments, variations, and modifications will be apparent to those skilled in the art. The inventions should therefore not be limited to the particular embodiments discussed above, but rather are defined by the claims. Furthermore, the claims are drafted with alphanumeric identifiers to distinguish the elements thereof. However, such identifiers are merely provided for convenience in reading, and should not necessarily be construed as requiring or implying a particular order of steps, or a particular sequential relationship among the claim elements.

What is claimed is:

1. A method for communicating from a printer to a remote support location, comprising:
receiving an affirmative request for an assistance from a user of a printer:
said request having been triggered by said user's engaging a button on said printer;
generating and transmitting a request for assistance to a remote support location in response to said user's request; and
providing an indication to said user that a request for assistance has been transmitted.

2. The method of claim 1 at least one step of which is conditioned on verifying authorization of said user.

3. The method of claim 2 where said verification includes biometric authentication.

4. The method of claim 2 where said verification occurs at said printer

5. The method of claim 2 where said verification occurs at said remote location.

6. The method of claim 2 where:
said remote location includes a computer sending a print job to said printer;
said print job being suspended until said user is at physically said printer; and
said request for assistance includes a verification that user is physically at said printer.

7. The method of claim 1 further comprising:
receiving a response from said remote location; and
conducting an interactive communication between said user and said remote location.

8. The method of claim 7 further comprising conditioning said interactive communication on authorization of said remote location.

9. The method of claim 7 where said interactive communication is performed using VoIP.

10. The method of claim 7 where said interactive communication includes allowing said remote location to interrogate said printer.

11. The method of claim 10 where said interactive communication includes establishing a service call for said printer.

12. The method of claim 1 where:
said printer acts as a gateway to at least another device connected thereto; and
said request includes information of said another device.

13. The method of claim 12 where said information pertains to a print spooler feeding said printer from said another device.

14. The method of claim 12 where said another device includes a consumer electronic device.

15. The method of claim 12 further comprising receiving said requested information in response to a user-initiated download request.

16. The method of claim 12:
where said another device includes a computer driving said printer; and
further comprising: receiving an updated driver for said computer, and transmitting said driver to said computer.

17. The method of claim 1 further comprising:
before at least said transmitting, attempting to locally resolve a problem at said printer; and
transmitting said request in response to a failure of local resolution.

18. The method of claim 1 where said remote location includes a service establishment independent from an owner of said printer.

19. The method of claim 1 implemented in a facsimile machine.

20. The method of claim 1 implemented in a copier.

21. The method of claim 1 where said request includes information pertaining to characteristics of a print job being processed.

22. The method of claim 1 where said request includes information pertaining to a physical status of said printer.

23. The method of claim 1 where said request includes identification information of said printer.

24. The method of claim 1 further comprising providing an indication of unavailability while said printer remains out of service.

25. The method of claim 1 where said request includes audiovisual information captured from said user.

26. The method of claim 1 wherein at least one of said printer and said remote location is protected by a firewall, and further comprising communicating between said printer and said remote location via a channel in said firewall.

27. A computer-readable medium for communicating from a printer to a remote support location, comprising computer logic instructions that, when executed:
receive an affirmative request for an assistance from a user of a printer:
said request having been triggered by said user's engaging a button on said printer;
generate and transmit a request for assistance to a remote support location in response to said user's request; and
provide an indication to said user that a request for assistance has been transmitted.

28. The computer-readable medium of claim 27 further comprising logic instructions that when executed:
receive a response from said remote location; and
conduct an interactive communication between said user and said remote location.

29. The computer-readable medium of claim 28 further comprising logic instructions for conditioning said interactive communication on authorization of said remote location.

30. The computer-readable medium of claim 27 further comprising logic instructions for implementing VoIP communications.

31. The computer-readable medium of claim 27 where:
said printer acts as a gateway to at least another device connected thereto; and
said request includes information of said another device.

32. Apparatus for communicating from a printer to a remote support location, comprising:
means for receiving an affirmative request for an assistance from a user of a printer:
said request having been triggered by said user's engaging a button on said printer;
means for generating and transmitting a request for assistance to a remote support location in response to said user's request; and
means for providing an indication to said user that a request for assistance has been transmitted.

33. A printer capable of communicating with a remote support location, comprising:
a printer engine;
an external button configured to be engaged by a user of said printer making an affirmative request for an assistance;
request management circuitry for generating and transmitting an assistance request in response to said user's affirmative request; and
a network interface for transmitting said assistance request to a remote location capable of communicating with said printer.

34. The printer of claim 33 further comprising authentication circuitry for authorization of said user.

35. The printer of claim 33 further comprising:
receiving a response from said remote location; and
conducting an interactive communication between said user and said remote location.

36. The printer of claim 35 further comprising VoIP circuitry for performing said interactive communication.

37. The printer of claim 33 where:
said printer acts as a gateway to at least another device connected thereto; and
said request includes information of said another device.

38. A method for receiving a communication from a printer at a remote support location, comprising:
receiving an affirmative request for an assistance from a user of a printer:
said request having been triggered by said user's engaging a button on said printer;
establishing an interactive communication over a communications network with said user at said printer.

39. The method of claim 38 further providing authorization of said remote location to said printer.

40. The method of claim 38 where said interactive communication is performed using VoIP.

41. The method of claim 38 where said interactive communication includes interrogation of said printer by said remote location.
